(19) United States
(12) Patent Application Publication
(10) Pub. No.: US 2023/0334168 A1
(43) Pub. Date: Oct. 19, 2023

(54) TIERED DATA SHARING PRIVACY ASSURANCE

(71) Applicants: University College Dublin, Dublin (IE); Inlecom Group BVBA, Brussels (BE)

(72) Inventors: Ibad Kureshi, Spennymoor (GB); Raymond James Genoe, Wicklow (IE); Robert Michael Dowdall, Louth (IE); Cormac James Doherty, Skerries (IE); Antonios Mygiakis, Chalandri (GR)

(73) Assignees: University College Dublin, National University of Ireland, Dublin, Dublin (IE); Inlecom Group BVBA, Brussels (BE)

(21) Appl. No.: 17/720,193

(22) Filed: Apr. 13, 2022

(51) Int. Cl. G06F 21/62

(52) U.S. Cl. CPC G06F 21/6245; G06F 2221/2101

(57) ABSTRACT

Embodiments of the present invention provide a method, system and computer program product for tiered data sharing privacy assurance in responding for requests to inspect investigative data. In an embodiment of the invention, a method for tiered data sharing privacy assurance in responding for requests to inspect investigative data includes receiving a request to access investigative data and applying a privacy test to the request to determine if the request is specific for an individual or generic to any individual. On condition that the privacy test is determined to be generic, the request may be denied. But otherwise, on condition the test is determined to be specific, a data sharing rule that defines a degree to which the investigative data is to be shared may be applied and the request responded to according to the defined degree.

### STATEMENT REGARDING GOVERNMENTALLY SPONSORED RESEARCH OR DEVELOPMENT

The project leading to this application has received funding from the European Union's Horizon 2020 research and innovation programme under grant agreement No 833276.

### BACKGROUND OF THE INVENTION

### Field of the Invention

The present invention relates to the field of information sharing and more particularly to the privacy assurance during information sharing.

### Description of the Related Art

Data sharing forms the backbone of inter-enterprise computer communications. For general, intra-enterprise computing, the sharing of data amongst different computing systems of a single organization generally is without restriction since the data shared between computing systems can be accessed only by the insiders of the single organization. On the other hand, for inter-enterprise computing, the sharing of data amongst different computing systems of respectively different organizations presents challenges in the form of restricting which data can be accessed by which organization in order to assure data security and data privacy. Solutions for managing information sharing in this instance range from data storage level solutions in which individual tables or records are subject to access control policies, to higher level proxies limiting access to data according to the identity of the requestor without providing direct access to the underlying data store.

In both the case of intra-enterprise and inter-enterprise computing, the assurance of individual privacy remains of paramount concern. To that end, oftentimes, access control mechanisms limit the type of information able to be accessed by a specific requestor. For outside requestors not internal to an organization, however, access control can become challenging as the identity or role of a requestor cannot be known a priori so as to apply an optimal access control rule. Consequently, an administrative burden arises requiring an administrator to intervene for every individual outside of an organization seeking access to data within the organization. To provide efficient access to information by a priori unknown requestors, then, generic rules regarding data access are imposed such as the reduction of personally identifying information. However, in some instances, a requestor requires access to personally identifying information but cannot receive the required access owing to the need to assure privacy of the personally identifying information for all prospective requestors.

### BRIEF SUMMARY OF THE INVENTION

Embodiments of the present invention address deficiencies of the art in respect to privacy assurance during information sharing and provide a novel and non-obvious method, system and computer program product for tiered data sharing privacy assurance. In an embodiment of the invention, a method for tiered data sharing privacy assurance includes receiving a request to access investigative data and applying a privacy test to the request to determine if the request is specific for an individual or generic to any individual. On condition that the privacy test is determined to be generic, the request may be denied. But otherwise, on condition the test is determined to be specific, a data sharing rule that defines a degree to which the investigative data is to be shared may be applied and the request responded to according to the defined degree.

In one aspect of the embodiment, the application of the privacy test includes transforming the request into a vector of one or more criteria and comparing the criteria to a specified minimum combination of the criteria set forth in the privacy test. Then, it is determined that the test is specific to an individual responsive to the criteria of the request meeting or exceeding the specified minimum combination, but otherwise determining that the test is generic. To that end, the specified minimum combination of the criteria can be drawn from a relationship graph of nodes, with each of the nodes in the graph corresponding to specific criteria and each of the nodes connecting to different related criteria to the specific criteria, and each of the nodes specifying a minimum number of the different related criteria that must be present in the vector when the specific criteria is present in the request.

In another aspect of the embodiment, the data sharing rule specifies a degree of obfuscation of the investigative data according to a jurisdiction associated with the request. For example, the degree of obfuscation is less for a jurisdiction within a same national boundary as a source of the investigative data, but the degree of obfuscation is greater for a jurisdiction within a different national boundary than the source of the investigative data.

In another embodiment of the invention, a data processing system can be adapted for tiered data sharing privacy assurance in responding for requests to inspect investigative data. The system includes a host computing platform having one or more computers, each with memory and at least one processor. The system also includes a tiered data sharing module. The module includes computer program instructions enabled while executing in the host computing platform to receive in the memory of the host computing system, a request to access investigative data and to apply a privacy test to the request to determine if the request is specific for an individual or generic to any individual. Then, on the condition that the privacy test is determined to be generic, the request is denied, but otherwise on condition the test is determined to be specific, a data sharing rule is applied that defines a degree to which the investigative data is to be shared and responding to the request according to the defined degree.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for tiered data sharing privacy assurance;

FIG. 2 is a schematic diagram of a computer data processing system adapted for tiered data sharing privacy assurance; and,

FIG. 3 is a flow chart illustrating a process for tiered data sharing privacy assurance.

### DETAILED DESCRIPTION OF THE INVENTION

Embodiments of the invention provide for tiered data sharing privacy assurance. In accordance with an embodiment of the invention, a data request to access data can be received in a query interface to an enterprise information system. The data request can then be decomposed into its constituent components and the components can be assembled into a query vector combining the components. Based upon the components it can be determined if the data request is directed to a specific individual or to a generic individual. In the former instance, the data request can be processed according to data access rules so as to produce a privacy assured result set for return to the requestor. But, in the latter instance, the data request can be denied even before subjecting the data request to the data access rules, as reflecting a shotgun approach to data discovery.

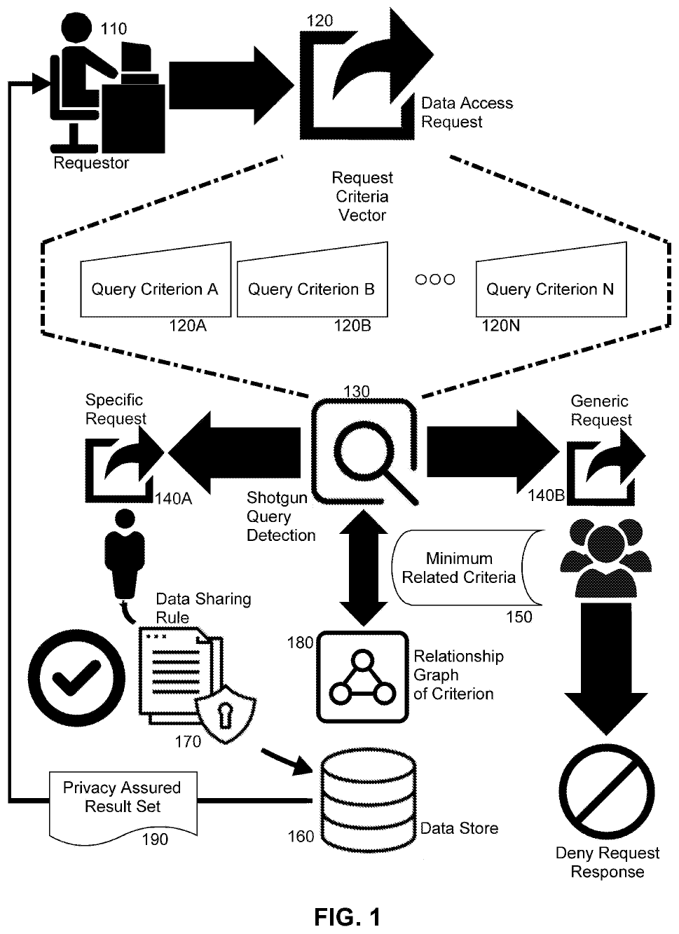

In further illustration, FIG. 1 is pictorial illustration of a process for tiered data sharing privacy assurance. As shown in FIG. 1, a requestor 110 issues a data access request 120 to retrieve data from data store 160. As part of a initial tier of privacy assurance, shotgun query detection logic 130 deconstructs the data access request 120 into its constituent criterion 120A, 120B, 120N—namely the fields specified within a query included as part of the data access request 120. The shotgun query detection logic 130 then inspects a relationship graph of criterion 180 for each of the constituent criterion 120A, 120B, 120N of the data access request 120 in order to locate a node in the relationship graph 180 for each of the criterion 120A, 120B, 120N. In this regard, each node in the relationship graph 180 provides an indication of directly related other criterion for a specified criterion and a minimum relationship quantity for the specified criterion.

As such, the shotgun query detection logic 130 determines for the constituent criterion 120A, 120B, 120N in respect to the relationship graph 180, minimum related criteria 150 and whether or not the request criterion vector of the constituent criterion 120A, 120B, 120N satisfies the minimum related criteria 150 for each of the constituent criterion 120A, 120B, 120N. For instance, the relationship graph 180 may indicate that a specific field included in the data access request 120 as one of the criterion 120A, 120B, 120N, at least two of a specified several other specific fields related to the specific field in the relationship graph 180 must be included as part of the criterion 120A, 120B, 120N in order for the data access request 120 to be determined to have met the minimum related criteria 150. But, for a different field included in the data access request 120 as one of the criterion 120A, 120B, 120N, the relationship graph may indicate that only one other specific field be included as part of the criterion 120A, 120B, 120N in order for the data access request 120 to be determined to have met the minimum criteria 150. Examples include, if a specific field is a last name, a city of residence also must be provided. Another example includes, if a specific field is a first name, then at least two of a phone number and date of birth and a country of citizenship must be provided as specific fields as well in order to indicate a specific request rather than a generic request.

If the shotgun query detection logic 130 determines that the request criterion vector of the constituent criterion 120A, 120B, 120N satisfies the minimum related criteria 150 for each of the constituent criterion 120A, 120B, 120N, the shotgun query detection logic 180 concludes that the data access request 120 is a generic request 140B not specific to any particular individual. Consequently, the data access request is denied. But, on the condition that the request criterion vector of the constituent criterion 120A, 120B, 120N satisfies the minimum related criteria 150, the shotgun query detection logic 180 concludes that the data access request 120 is a specific request 140A for a specific individual. As such, as a second tier of privacy assurance, a data sharing rule 170 is applied to the requested data in the data store 160 in order to produce a privacy assured result set 190 for return to the requestor 110. For instance, the data sharing rule 170 can specify different portions of the result set that are to be redacted or excluded such as the digits of an identity value of an individual, or the age of an individual. Notably, the data sharing rule 170 can vary based upon an identity or role of the requestor 110.

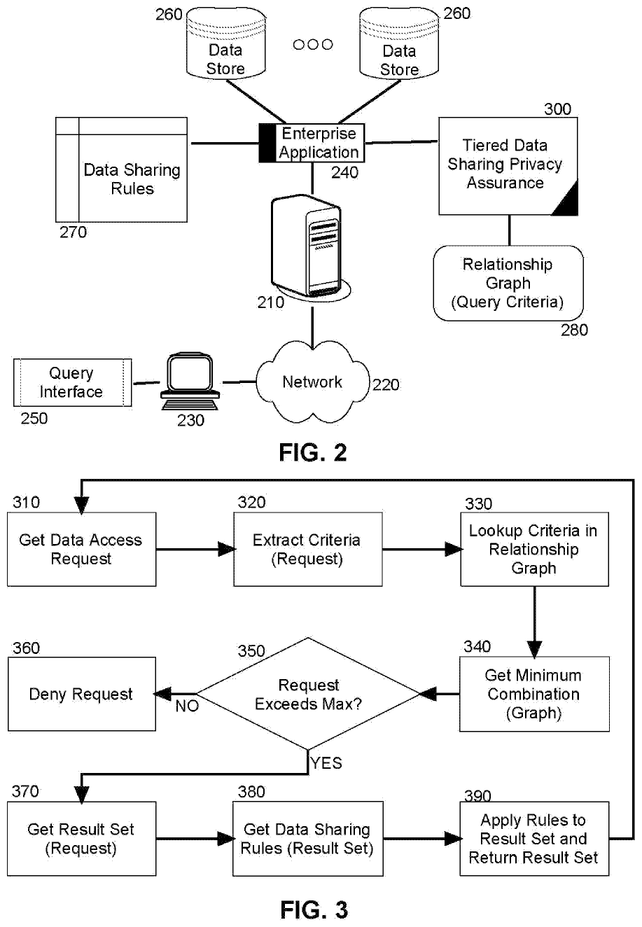

The process described in connection with FIG. 1 can be implemented within a computer data processing system. In further illustration, FIG. 2 schematically shows a computer data processing system adapted for tiered data sharing privacy assurance. The system includes a host computing platform 210 that includes one or more computers, each with memory and at least one processor. The host computing platform 210 supports the operation of an enterprise application 240 moderating access to information in one or more data stores 260. In particular, the enterprise application 240 processes data access requests received from a query interface 250 in a corresponding computing client 230 from over computer communications network 220.

Importantly, tiered data sharing privacy assurance module 300 is coupled to the enterprise application 240. The tiered data sharing privacy assurance module 300 includes computer program instructions operable upon execution in the host computing platform 210 to deconstruct a data access request received from the query interface 250 into constituent criterion, such as column identifiers (fields). The program instructions then retrieve a minimum combination of the criteria in order to consider the data access request specific to a particular individual rather than generic to any number of individuals. In this regard, the minimum combination of the criteria can be as simple as a minimum number of column identifiers, or the minimum combination can be a more complex requirement that varies in terms of number and identity of column identifiers based upon a specific column identifier present in the data access request. In one aspect of the embodiment, the program instructions query a relationship graph 280 with the query criteria in order to retrieve an indication of the minimum combination.

Once the minimum combination has been determined for the data access request, the program instructions compute whether or not the minimum combination exists in the data access request. If not, the program instructions deny the data access request as being generic in nature and reflective of a shotgun approach to data access and retrieval likely to breach upon privacy requirements of the enterprise application 240. But, to the extent that the program instructions determine that the minimum combination exists in the data access request, the program instructions permit the enterprise application 240 to produce a result set of data from the data store 260 and, according to a second tier of privacy assurance, the program instructions of the module 300 apply one or more data sharing rules 270 to the result set before permitting the enterprise application 240 to return the privacy assured result set to the query interface 250.

In yet further illustration of the operation of the tiered data sharing privacy assurance module 300, FIG. 3 is a flow chart illustrating a process for tiered data sharing privacy assurance. Beginning in block 310, a data access request is received that includes one or more criterion for conducting a query, and in block 320 the criteria of the request can be extracted. In block 330, the criteria are submitted to a relationship graph in order to determine, for each criterion, a minimum combination of criterion necessary to be present in order to conclude that the data access request is specific and not generic. In block 340, the minimum combination is received from the relationship graph and in decision block 350, it is determined whether or not the criteria of the data access request meets the requirement of the minimum combination. If not, in block 360 the data access request is denied. But otherwise, in block 370 a result set is received for the data access request and in block 380, on or more data sharing rules are retrieved for the data access request and the rules are then applied to the result set in block 390. In this way, a tiered approach to data sharing privacy is achieved.

The present invention may be embodied within a system, a method, a computer program product or any combination thereof. The computer program product may include a non-transitory computer readable storage medium or media having computer readable program instructions stored thereon, which when executed within the computer, cause one or more processors to perform different processes exemplary of different aspects of the present invention. To that end, the non-transitory computer readable storage medium can be a tangible device that can retain and store instructions for use by an instruction execution device such as a processor (central processing unit or “CPU”).

Aside from direct loading from memory for execution by one or more cores of a CPU or multiple CPUs, the computer readable program instructions described herein alternatively can be downloaded from over a computer communications network into the memory of a computer for execution therein. As well, only a portion of the program instructions may be retrieved into memory of the computing device from over a computer communications network, while other portions may be loaded from persistent storage of the computing device. Even further, only a portion of the program instructions may execute by one or more processing cores of one or more CPUs of the computing devices while other portions may cooperatively execute within a different computing device positioned remotely over the computer communications network with results of the computing by both devices shared therebetween.

Even yet further, as it is to be understood, one or more aspects of the present invention have been described herein with reference to flowchart illustrations and/or block diagrams of methods, apparatus (data processing systems), and computer program products according to embodiments of the invention. It will be understood that each block of the flowchart illustrations and/or block diagrams, and combinations of blocks in the flowchart illustrations and/or block diagrams, can be implemented by computer readable program instructions in various combinations. These computer readable program instructions may be provided to a CPU of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “include”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for tiered data sharing privacy assurance, the method comprising:
receiving in memory of a host computing system, a request to access investigative data;
applying a privacy test to the request to determine if the request is specific for an individual or generic to any individual; and,
on condition the privacy test is determined to be generic, denying the request but otherwise on condition the test is determined to be specific, applying a data sharing rule defining a degree to which the investigative data is to be shared and responding to the request according to the defined degree.

2. The method of claim 1, wherein the application of the privacy test comprises:
transforming the request into a vector of one or more criteria;
comparing the criteria to a specified minimum combination of the criteria set forth in the privacy test; and,
determining that the test is specific to an individual responsive to the criteria of the request meeting or exceeding the specified minimum combination, but otherwise determining that the test is generic.

3. The method of claim 2, wherein the specified minimum combination of the criteria is drawn from a relationship graph of nodes, each of the nodes in the graph corresponding to a specific criteria and each of the nodes connecting to different related criteria to the specific criteria, and each of the nodes specifying a minimum number of the different related criteria that must be present in the vector when the specific criteria is present in the request.

4. The method of claim 1, wherein the data sharing rule specifies a degree of obfuscation of the investigative data according to a jurisdiction associated with the request.

5. The method of claim 4, wherein the degree of obfuscation is less for a jurisdiction within a same national boundary as a source of the investigative data, but the degree of obfuscation is greater for a jurisdiction within a different national boundary than the source of the investigative data.

6. A data processing system adapted for tiered data sharing privacy assurance, the system comprising:
a host computing platform comprising one or more computers, each comprising memory and at least one processor; and,
a tiered data sharing module comprising computer program instructions enabled while executing in the host computing platform to perform:
receiving in the memory of the host computing system, a request to access investigative data;
applying a privacy test to the request to determine if the request is specific for an individual or generic to any individual; and,
on condition the privacy test is determined to be generic, denying the request but otherwise on condition the test is determined to be specific, applying a data sharing rule defining a degree to which the investigative data is to be shared and responding to the request according to the defined degree.

7. The system of claim 6, wherein the application of the privacy test comprises:
transforming the request into a vector of one or more criteria;
comparing the criteria to a specified minimum combination of the criteria set forth in the privacy test; and,
determining that the test is specific to an individual responsive to the criteria of the request meeting or exceeding the specified minimum combination, but otherwise determining that the test is generic.

8. The system of claim 7, wherein the specified minimum combination of the criteria is drawn from a relationship graph of nodes, each of the nodes in the graph corresponding to a specific criteria and each of the nodes connecting to different related criteria to the specific criteria, and each of the nodes specifying a minimum number of the different related criteria that must be present in the vector when the specific criteria is present in the request.

9. The system of claim 6, wherein the data sharing rule specifies a degree of obfuscation of the investigative data according to a jurisdiction associated with the request.

10. The system of claim 9, wherein the degree of obfuscation is less for a jurisdiction within a same national boundary as a source of the investigative data, but the degree of obfuscation is greater for a jurisdiction within a different national boundary than the source of the investigative data.

11. A computer program product for tiered data sharing privacy assurance, the computer program product including a computer readable storage medium having program instructions embodied therewith, the program instructions executable by a device to cause the device to perform a method including:
receiving in memory of a host computing system, a request to access investigative data;
applying a privacy test to the request to determine if the request is specific for an individual or generic to any individual; and,
on condition the privacy test is determined to be generic, denying the request but otherwise on condition the test is determined to be specific, applying a data sharing rule defining a degree to which the investigative data is to be shared and responding to the request according to the defined degree.

12. The computer program product of claim 11, wherein the application of the privacy test comprises:
transforming the request into a vector of one or more criteria;
comparing the criteria to a specified minimum combination of the criteria set forth in the privacy test; and,
determining that the test is specific to an individual responsive to the criteria of the request meeting or exceeding the specified minimum combination, but otherwise determining that the test is generic.

13. The computer program product of claim 13, wherein the specified minimum combination of the criteria is drawn from a relationship graph of nodes, each of the nodes in the graph corresponding to a specific criteria and each of the nodes connecting to different related criteria to the specific criteria, and each of the nodes specifying a minimum number of the different related criteria that must be present in the vector when the specific criteria is present in the request.

14. The computer program product of claim 11, wherein the data sharing rule specifies a degree of obfuscation of the investigative data according to a jurisdiction associated with the request.

15. The computer program product of claim 14, wherein the degree of obfuscation is less for a jurisdiction within a same national boundary as a source of the investigative data, but the degree of obfuscation is greater for a jurisdiction within a different national boundary than the source of the investigative data.
